(19) United States
(12) Patent Application Publication
(10) Pub. No.: US 2015/0281006 A1
(43) Pub. Date: Oct. 1, 2015

(54) METHOD AND APPARATUS DISTRIBUTED MULTI- CLOUD RESIDENT ELASTIC ANALYTICS ENGINE

(71) Applicant: Avni Networks Inc., Milpitas, CA (US)

(72) Inventors: Rohini Kumar KASTURI, Sunnyvale, CA (US); Satish GRANDHI, Santa Clara, CA (US); Vijay Sundar RAJARAM, Fremont, CA (US); Baranidharan SEETHARAMAN, Sunnyvale, CA (US); Vibhu PRATAP, Santa Clara, CA (US)

(21) Appl. No.: 14/683,130

(22) Filed: Apr. 9, 2015

Related U.S. Application Data
(63) Continuation-in-part of application No. 14/681,057, filed on Apr. 7, 2015.
Application No. 14/681,057 is a continuation-in-part of application No. 14/214,682, filed on Mar. 15, 2014.
Application No. 14/214,682 is a continuation-in-part of application No. 14/214,666, filed on Mar. 15, 2014.
Application No. 14/214,666 is a continuation-in-part of application No. 14/214,612, filed on Mar. 14, 2014.
Application No. 14/214,612 is a continuation-in-part of application No. 14/214,572, filed on Mar. 14, 2014.
Application No. 14/214,572 is a continuation-in-part of application No. 14/214,472, filed on Mar. 14, 2014.
Application No. 14/214,472 is a continuation-in-part of application No. 14/214,326, filed on Mar. 14, 2014.
(60) Provisional application No. 61/978,078, filed on Apr. 10, 2014.

(51) Int. Cl. H04L 12/24; H04L 29/08

(52) U.S. Cl. CPC H04L 41/5058; H04L 67/02; H04L 67/10; H04L 41/5009

(57) ABSTRACT

A multi-cloud fabric system includes a distributed elastic SLA analyzer and a distributed elastic analytic correlator. The distributed elastic SLA analyzer provides aggregated network state information to the distributed elastic analytic correlator and the distributed elastic analytic correlator, correlates the aggregated network state information from more than one network services for optimization of the multi-cloud fabric system.

### CROSS-REFERENCE TO RELATED APPLICATIONS

This application claims priority to U.S. Provisional Patent Application No. 61/978,078, filed on Apr. 10, 2014, by Rohini Kumar Kasturi, et al., and entitled “METHOD AND APPARATUS DISTRIBUTED MULTI-CLOUD RESIDENT ELASTIC ANALYTICS ENGINE”, and is a continuation-in-part of U.S. patent application Ser. No. 14/681,057, filed on Apr. 7, 2015, by Rohini Kumar Kasturi, et al., and entitled “SMART NETWORK AND SERVICE ELEMENTS”, which is a continuation-in-part of U.S. patent application Ser. No. 14/214,682, filed on Mar. 17, 2014, by Kasturi et al. and entitled “METHOD AND APPARATUS FOR CLOUD BURSTING AND CLOUD BALANCING OF INSTANCES ACROSS CLOUDS”, which is a continuation-in-part of U.S. patent application Ser. No. 14/214,666, filed on Mar. 17, 2014, by Kasturi et al., and entitled “METHOD AND APPARATUS FOR AUTOMATIC ENABLEMENT OF NETWORK SERVICES FOR ENTERPRISES”, which is a continuation-in-part of U.S. patent application Ser. No. 14/214,612, filed on Mar. 14, 2014, by Kasturi et al., and entitled “METHOD AND APPARATUS FOR RAPID INSTANCE DEPLOYMENT ON A CLOUD USING A MULTI-CLOUD CONTROLLER”, which is a continuation-in-part of U.S. patent application Ser. No. 14/214,572, filed on Mar. 14, 2014, by Kasturi et al., and entitled “METHOD AND APPARATUS FOR ENSURING APPLICATION AND NETWORK SERVICE PERFORMANCE IN AN AUTOMATED MANNER”, which is a continuation-in-part of U.S. patent application Ser. No. 14/214,472, filed on Mar. 14, 2014, by Kasturi et al., and entitled, “PROCESSES FOR A HIGHLY SCALABLE, DISTRIBUTED, MULTI-CLOUD SERVICE DEPLYMENT, ORCHESTRATION AND DELIVERY FABRIC”, which is a continuation-in-part of U.S. patent application Ser. No. 14/214,326, filed on Mar. 14, 2014, by Kasturi et al., and entitled, “METHOD AND APPARATUS FOR HIGHLY SCALABLE, MULTI-CLOUD SERVICE DEVELOPMENT, ORCHESTRATION AND DELIVERY”, which are incorporated herein by reference as though set forth in full.

### FIELD OF THE INVENTION

Various embodiments of the invention relate generally to multi-user and multi-cloud network systems and particularly to optimization of the network system using state information.

### BACKGROUND

Data centers refer to facilities used to house computer systems and associated components, such as telecommunications (networking equipment) and storage systems. They generally include redundancy, such as redundant data communications connections and power supplies. These computer systems and associated components generally make up the Internet. A metaphor for the Internet is cloud.

A large number of computers connected through a real-time communication network such as the Internet generally form a cloud. Cloud computing refers to distributed computing over a network, and the ability to run a program or application on many connected computers of one or more clouds at the same time.

The cloud has become one of the, or perhaps even the, most desirable platform for storage and networking. A data center with one or more clouds may have servers, switches, storage systems, and other networking and storage hardware (or equipment), but actually served up by virtual hardware, simulated by software running on one or more networking machines and storage systems. Therefore, virtual servers, storage systems, switches and other networking equipment are employed but they do not exist necessarily as equipment or hardware and can therefore be moved around and scaled up or down on the fly without any difference to the end user, somewhat like a cloud becoming larger or smaller without being a physical object. Cloud bursting refers to a cloud, including networking equipment, becoming larger or smaller.

Cloud computing allows companies to avoid upfront infrastructure costs, and focus on projects that differentiate their businesses, not their infrastructure. It further allows enterprises to get their applications up and running faster, with improved manageability and less maintenance, and to enable information technology (IT) to more rapidly adjust resources to meet fluctuating and unpredictable business demands.

Fabric computing or unified computing involves the creation of a computing fabric system consisting of interconnected nodes that look like a ‘weave’ or a ‘fabric’ when viewed collectively from a distance. Usually this refers to a consolidated high-performance computing system consisting of loosely coupled storage, networking and parallel processing functions linked by high bandwidth interconnects.

The fundamental components of fabrics are “nodes” (processor(s), memory, and/or peripherals) and “links” (functional connection between nodes). Manufacturers of fabrics (or fabric systems) include companies, such as IBM and Brocade. These companies provide examples of fabrics made of hardware. Fabrics are also made of software or a combination of hardware and software.

Currently, network services generally operate independently of each other, therefore, in multiple clouds (“multi-cloud”) environments or systems, inefficiencies arise leading to less-than-optimal performance.

### SUMMARY

Briefly, a multi-cloud fabric system includes a distributed elastic SLA analyzer and a distributed elastic analytic correlator. The distributed elastic SLA analyzer provides aggregated network state information to the distributed elastic analytic correlator and the distributed elastic analytic correlator, correlates the aggregated network state information from more than one network services for optimization of the multi-cloud fabric system.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a data center 100, in accordance with an embodiment of the invention.

FIG. 2 shows details of relevant portions of the data center 100 and in particular, the fabric system 106 of FIG. 1.

FIG. 3 shows, conceptually, various features of the data center 300, in accordance with an embodiment of the invention.

FIG. 4 shows, in conceptual form, relevant portions of a multi-cloud data center 400, in accordance with another embodiment of the invention.

FIGS. 4a-c show exemplary data centers configured using various embodiments and methods of the invention.

FIG. 5 shows a controller unit 900, in accordance with an embodiment of the invention.

FIG. 6 shows a services controller 950, in accordance with an embodiment of the invention.

FIG. 7 shows flow charts of some of the relevant steps 980 performed by the services controller 950, in accordance with various methods of the invention.

FIG. 8 shows a networking system using various methods and embodiments of the invention.

FIG. 9 shows an example of a distributed elastic analytic engine 1500, in accordance with methods and embodiments of the invention.

FIG. 10 shows an example of a distributed elastic network service 2000 in communication with the distributed elastic receiver cluster 1520 of FIG. 9, in accordance with embodiment and method of the invention.

FIG. 11 shows, in block diagram form, a relevant portion of a data center with network elements, in accordance with an embodiment and method of the invention.

FIG. 12 shows an example of a distributed elastic analytic correlator 3000 residing on the service controller, in accordance with embodiment and method of the invention.

### DETAILED DESCRIPTION OF EMBODIMENTS

Clouds try to maximize the effectiveness of shared resources, “resources” being machines or hardware such as storage systems and/or networking equipment. Sometimes, these resources are referred to as “instances” or “elements”. In embodiments and methods disclosed and anticipated herein, cloud resources are not only shared by multiple users but are also optimally employed and therefore increase allocation of resources to users.

In an example of a cloud computer facility, or a data center, that serves Australian users during Australian business hours with a specific application (e.g., email), the same resources may be reallocated to serve North American users during North America's business hours with a different application (e.g., a web server). With cloud computing, multiple users can access a single server to retrieve and update their data without purchasing licenses for different applications. However, currently, due to inefficiencies and less-than-optimal conditions, resources are ineffectively allocated resulting in system crashes or needless redundancies of costly equipment that leads to unnecessary expenses. In light of large data becoming more popular and larger, if you will, as a primary result of newly-discovered utilizations of the internet, costs increase by orders of magnitude. In accordance with various embodiments and methods of the invention, optimization of resources by centralization and correlation of network state information from multiple network services and clouds, accessible to multiple users, results in cost benefits and performance improvement. Thus, not only are system crashes far less likely to the point of non-existent, optimization of network state information is realized.

The following description describes a multi-cloud fabric system. The multi-cloud fabric system has a compiler that uses one or more data models to generate artifacts for use by a (master or slave) controller of a cloud thereby automating the process of building a user interface (UI). To this end, a data-driven rather than a manual approach is employed. This can be done among numerous clouds and clouds of different types.

In an embodiment and method of the invention, the artifacts are based on the controller being employed in the cloud.

In an embodiment and method of the invention, the compiler generates different artifacts for different controller. Artifacts are generated for orchestrated infrastructures automatically.

The data model used by the compiler is defined for the UI on an on-demand basis and typically when clouds are being added or removed or features and being added or removed and a host of other reasons.

The data model may be in any desired format, such as without limitation, XML.

Particular embodiments and methods of the invention disclose a virtual multi-cloud fabric system. Still other embodiments and methods disclose automation of application delivery by use of the multi-cloud fabric system.

In other embodiments, a data center includes a plug-in, application layer, multi-cloud fabric, network, and one or more the same or different types of clouds.

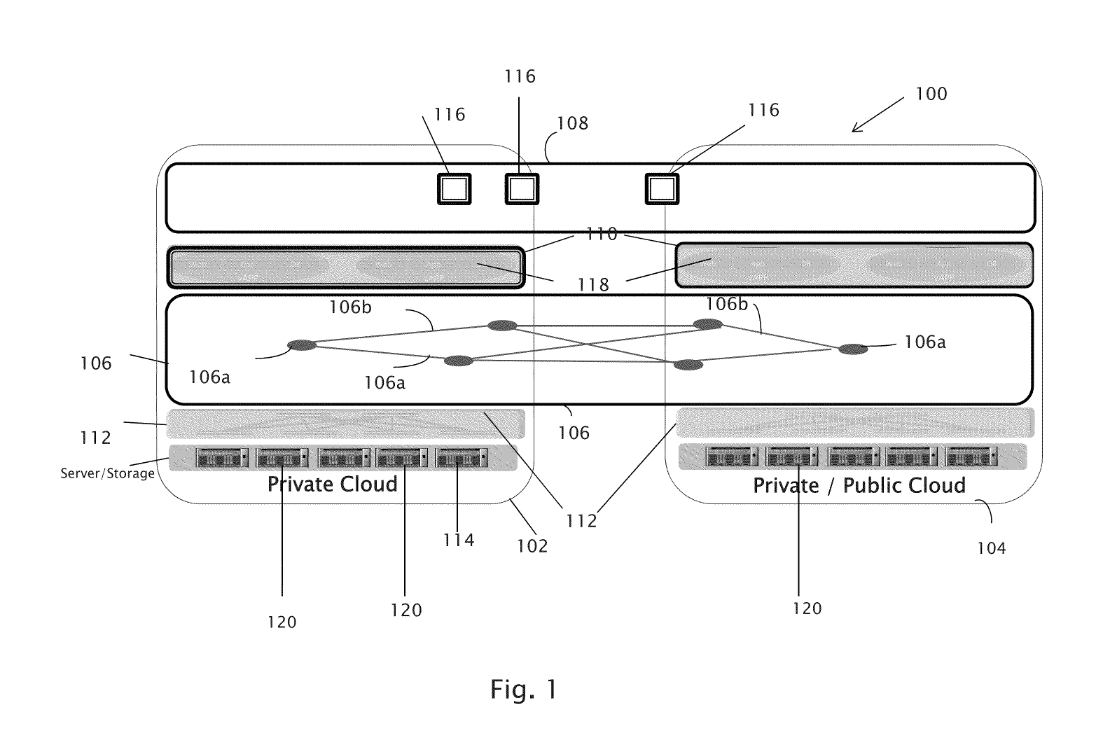

Referring now to FIG. 1, a data center 100 is shown, in accordance with an embodiment of the invention. The data center 100 is shown to include a private cloud 102 and a hybrid cloud 104. A hybrid cloud is a combination public and private cloud. The data center 100 is further shown to include a plug-in unit 108 and a multi-cloud fabric system 106 spanning across the clouds 102 and 104. Each of the clouds 102 and 104 are shown to include a respective application layer 110, a network 112, and resources 114.

The network 112 includes switches, router, and the like and the resources 114 includes networking and storage equipment, i.e. machines, such as without limitation, servers, storage systems, switches, servers, routers, or any combination thereof.

The application layers 110 are each shown to include applications 118, which may be similar or entirely different or a combination thereof.

The plug-in unit 108 is shown to include various plug-ins (orchestration). As an example, in the embodiment of FIG. 1, the plug-in unit 108 is shown to include several distinct plug-ins 116, such as one made by Opensource, another made by Microsoft, Inc., and yet another made by VMware, Inc. The foregoing plug-ins typically each use different formats. The plug-in unit 108 converts all of the various formats of the applications (plug-ins) into one or more native-format applications for use by the multi-cloud fabric system 106. The native-format application(s) is passed through the application layer 110 to the multi-cloud fabric system 106.

The multi-cloud fabric system 106 is shown to include various nodes 106a and links 106b connected together in a weave-like fashion. Nodes 106a are network, storage, or telecommunication or communications devices such as, without limitation, computers, hubs, bridges, routers, mobile units, or switches attached to computers or telecommunications network, or a point in the network topology of the multi-cloud fabric system 106 where lines intersect or terminate. Links 106b are typically data links.

In some embodiments of the invention, the plug-in unit 108 and the multi-cloud fabric system 106 do not span across clouds and the data center 100 includes a single cloud. In embodiments with the plug-in unit 108 and multi-cloud fabric system 106 spanning across clouds, such as that of FIG. 1, resources of the two clouds 102 and 104 are treated as resources of a single unit. For example, an application may be distributed across the resources of both clouds 102 and 104 homogeneously thereby making the clouds seamless. This allows use of analytics, searches, monitoring, reporting, displaying and otherwise data crunching thereby optimizing services and use of resources of clouds 102 and 104 collectively.

While two clouds are shown in the embodiment of FIG. 1, it is understood that any number of clouds, including one cloud, may be employed. Furthermore, any combination of private, public and hybrid clouds may be employed. Alternatively, one or more of the same type of cloud may be employed.

In an embodiment of the invention, the multi-cloud fabric system 106 is a Layer (L) 4-7 fabric system. Those skilled in the art appreciate data centers with various layers of networking. As earlier noted, multi-cloud fabric system 106 is made of nodes 106a and connections (or “links”) 106b. In an embodiment of the invention, the nodes 106a are devices, such as but not limited to L4-L7 devices. In some embodiments, the multi-cloud fabric system 106 is implemented in software and in other embodiments, it is made with hardware and in still others, it is made with hardware and software.

Some switches can use up to OSI layer 7 packet information; these may be called layer (L) 4-7 switches, content-switches, content services switches, web-switches or application-switches.

Content switches are typically used for load balancing among groups of servers. Load balancing can be performed on HTTP, HTTPS, VPN, or any TCP/IP traffic using a specific port. Load balancing often involves destination network address translation so that the client of the load balanced service is not fully aware of which server is handling its requests. Content switches can often be used to perform standard operations, such as SSL encryption/decryption to reduce the load on the servers receiving the traffic, or to centralize the management of digital certificates. Layer 7 switching is the base technology of a content delivery network.

The multi-cloud fabric system 106 sends one or more applications to the resources 114 through the networks 112.

In a service level agreement (SLA) engine, as will be discussed relative to a subsequent figure, data is acted upon in real-time. Further, the data center 100 dynamically and automatically delivers applications, virtually or in physical reality, in a single or multi-cloud of either the same or different types of clouds.

The data center 100, in accordance with some embodiments and methods of the invention, functions as a service (Software as a Service (SAAS) model, a software package through existing cloud management platforms, or a physical appliance for high scale requirements. Further, licensing can be throughput or flow-based and can be enabled with network services only, network services with SLA and elasticity engine (as will be further evident below), network service enablement engine, and/or multi-cloud engine.

As will be further discussed below, the data center 100 may be driven by representational state transfer (REST) application programming interface (API).

The data center 100, with the use of the multi-cloud fabric system 106, eliminates the need for an expensive infrastructure, manual and static configuration of resources, limitation of a single cloud, and delays in configuring the resources, among other advantages. Rather than a team of professionals configuring the resources for delivery of applications over months of time, the data center 100 automatically and dynamically does the same, in real-time. Additionally, more features and capabilities are realized with the data center 100 over that of prior art. For example, due to multi-cloud and virtual delivery capabilities, cloud bursting to existing clouds is possible and utilized only when required to save resources and therefore expenses.

Moreover, the data center 100 effectively has a feedback loop in the sense that results from monitoring traffic, performance, usage, time, resource limitations and the like, i.e. the configuration of the resources can be dynamically altered based on the monitored information. A log of information pertaining to configuration, resources, the environment, and the like allow the data center 100 to provide a user with pertinent information to enable the user to adjust and substantially optimize its usage of resources and clouds. Similarly, the data center 100 itself can optimize resources based on the foregoing information.

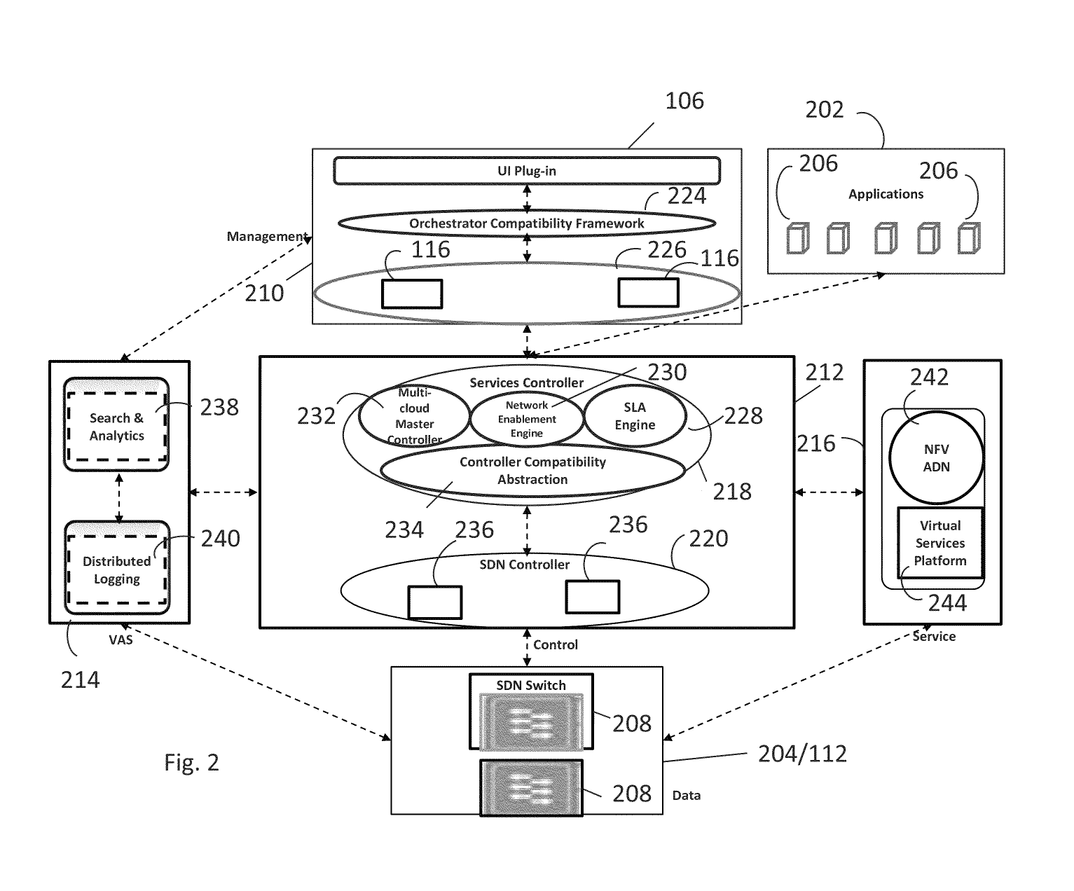

FIG. 2 shows further details of relevant portions of the data center 100 and in particular, the fabric system 106 of FIG. 1. The fabric system 106 is shown to be in communication with a applications unit 202 and a network 204, which is shown to include a number of Software Defined Networking (SDN)-enabled controllers and switches 208. The network 204 is analogous to the network 112 of FIG. 1.

The applications unit 202 is shown to include a number of applications 206, for instance, for an enterprise. These applications are analyzed, monitored, searched, and otherwise crunched just like the applications from the plug-ins of the fabric system 106 for ultimate delivery to resources through the network 204.

The data center 100 is shown to include five units (or planes), the management unit 210, the value-added services (VAS) unit 214, the controller unit 212, the service unit 216 and the data unit (or network) 204. Accordingly and advantageously, control, data, VAS, network services and management are provided separately. Each of the planes is an agent and the data from each of the agents is crunched by the controller unit 212 and the VAS unit 214.

The fabric system 106 is shown to include the management unit 210, the VAS unit 214, the controller unit 212 and the service unit 216. The management unit 210 is shown to include a user interface (UI) plug-in 222, an orchestrator compatibility framework 224, and applications 226. The management unit 210 is analogous to the plug-in 108. The UI plug-in 222 and the applications 226 receive applications of various formats and the framework 224 translates the various formatted application into native-format applications. Examples of plug-ins 116, located in the applications 226, are VMware ICenter, by VMware, Inc. and System Center by Microsoft, Inc. While two plug-ins are shown in FIG. 2, it is understood that any number may be employed.

The controller unit 212 serves as the master or brain of the data center 100 in that it controls the flow of data throughout the data center and timing of various events, to name a couple of many other functions it performs as the mastermind of the data center. It is shown to include a services controller 218 and a SDN controller 220. The services controller 218 is shown to include a multi-cloud master controller 232, an application delivery services stitching engine or network enablement engine 230, a SLA engine 228, and a controller compatibility abstraction 234.

Typically, one of the clouds of a multi-cloud network is the master of the clouds and includes a multi-cloud master controller that talks to local cloud controllers (or managers) to help configure the topology among other functions. The master cloud includes the SLA engine 228 whereas other clouds need not to but all clouds include a SLA agent and a SLA aggregator with the former typically being a part of the virtual services platform 244 and the latter being a part of the search and analytics 238.

The controller compatibility abstraction 234 provides abstraction to enable handling of different types of controllers (SDN controllers) in a uniform manner to offload traffic in the switches and routers of the network 204. This increases response time and performance as well as allowing more efficient use of the network.

The network enablement engine 230 performs stitching where an application or network services (such as configuring load balance) is automatically enabled. This eliminates the need for the user to work on meeting, for instance, a load balance policy. Moreover, it allows scaling out automatically when violating a policy.

The flex cloud engine 232 handles multi-cloud configurations such as determining, for instance, which cloud is less costly, or whether an application must go onto more than one cloud based on a particular policy, or the number and type of cloud that is best suited for a particular scenario.

The SLA engine 228 monitors various parameters in real-time and decides if policies are met. Exemplary parameters include different types of SLAs and application parameters. Examples of different types of SLAs include network SLAs and application SLAs. The SLA engine 228, besides monitoring allows for acting on the data, such as service plane (L4-L7), application, network data and the like, in real-time.

The practice of service assurance enables Data Centers (DCs) and (or) Cloud Service Providers (CSPs) to identify faults in the network and resolve these issues in a timely manner so as to minimize service downtime. The practice also includes policies and processes to proactively pinpoint, diagnose and resolve service quality degradations or device malfunctions before subscribers (users) are impacted.

Service assurance encompasses the following:
Fault and event management
   Performance management
   Probe monitoring
   Quality of service (QoS) management
   Network and service testing
   Network traffic management
   Customer experience management
   Real-time SLA monitoring and assurance
   Service and Application availability
   Trouble ticket management

The structures shown included in the controller unit 212 are implemented using one or more processors executing software (or code) and in this sense, the controller unit 212 may be a processor. Alternatively, any other structures in FIG. 2 may be implemented as one or more processors executing software. In other embodiments, the controller unit 212 and perhaps some or all of the remaining structures of FIG. 2 may be implemented in hardware or a combination of hardware and software.

VAS unit 214 uses its search and analytics unit 238 to search analytics based on distributed large data engine and crunches data and displays analytics. The search and analytics unit 238 can filter all of the logs the distributed logging unit 240 of the VAS unit 214 logs, based on the customer's (user's) desires. Examples of analytics include events and logs. The VAS unit 214 also determines configurations such as who needs SLA, who is violating SLA, and the like.

The SDN controller 220, which includes software defined network programmability, such as those made by Floodlight, Open Daylight, PDX, and other manufacturers, receives all the data from the network 204 and allows for programmability of a network switch/router.

The service plane 216 is shown to include an API based, Network Function Virtualization (NFV), Application Delivery Network (ADN) 242 and on a Distributed virtual services platform 244. The service plane 216 activates the right components based on rules. It includes ADC, web-application firewall, DPI, VPN, DNS and other L4-L7 services and configures based on policy (it is completely distributed). It can also include any application or L4-L7 network services.

The distributed virtual services platform contains an Application Delivery Controller (ADC), Web Application Firewall (Firewall), L2-L3 Zonal Firewall (ZFW), Virtual Private Network (VPN), Deep Packet Inspection (DPI), and various other services that can be enabled as a single-pass architecture. The service plane contains a Configuration agent, Stats/Analytics reporting agent, Zero-copy driver to send and receive packets in a fast manner, Memory mapping engine that maps memory via TLB to any virtualized platform/hypervisor, SSL offload engine, etc.

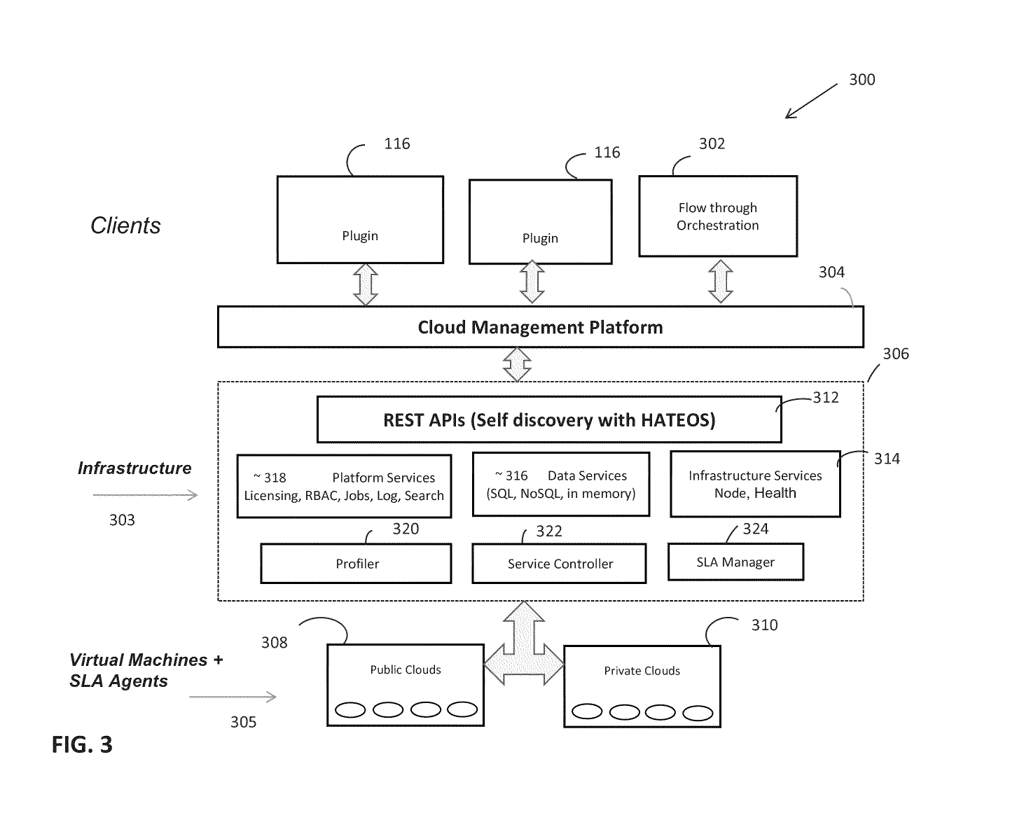

FIG. 3 shows conceptually various features of the data center 300, in accordance with an embodiment of the invention. The data center 300 is analogous to the data center 100 except some of the features/structures of the data center 300 are in addition to those shown in the data center 100. The data center 300 is shown to include plug-ins 116, flow-through orchestration 302, cloud management platform 304, controller 306, and public and private clouds 308 and 310, respectively.

The controller 306 is analogous to the controller unit 212 of FIG. 2. In FIG. 3, the controller 306 is shown to include a REST APIs-based invocations for self-discovery, platform services 318, data services 316, infrastructure services 314, profiler 320, service controller 322, and SLA manager 324.

The flow-through orchestration 302 is analogous to the framework 224 of FIG. 2. Plug-ins 116 and orchestration 302 provide applications to the cloud management platform 304, which converts the formats of the applications to native format. The native-formatted applications are processed by the controller 306, which is analogous to the controller unit 212 of FIG. 2. The RESI APIs 312 drive the controller 306. The platform services 318 is for services such as licensing, Role Based Access and Control (RBAC), jobs, log, and search. The data services 316 is to store data of various components, services, applications, databases such as Search and Query Language (SQL), NoSQL, data in memory. The infrastructure services 314 is for services such as node and health.

The profiler 320 is a test engine. Service controller 322 is analogous to the controller 220 and SLA manager 324 is analogous to the SLA engine 228 of FIG. 2. During testing by the profiler 320, simulated traffic is run through the data center 300 to test for proper operability as well as adjustment of parameters such as response time, resource and cloud requirements, and processing usage.

In the exemplary embodiment of FIG. 3, the controller 306 interacts with public clouds 308 and private clouds 310. Each of the clouds 308 and 310 include multiple clouds and communicate not only with the controller 306 but also with each other. Benefits of the clouds communicating with one another is optimization of traffic path, dynamic traffic steering, and/or reduction of costs, among perhaps others.

The plug-ins 116 and the flow-through orchestration 302 are the clients 310 of the data center 300, the controller 306 is the infrastructure of the data center 300, and the clouds 308 and 310 are the virtual machines and SLA agents 305 of the data center 300.

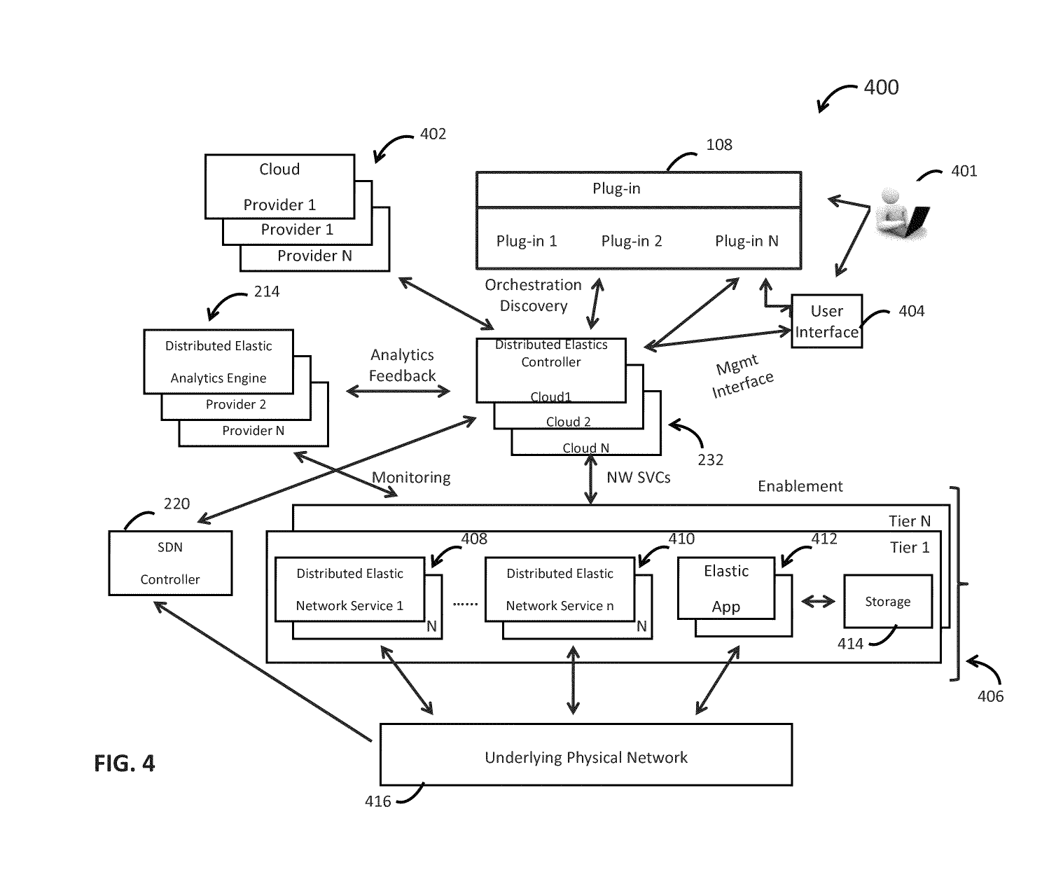

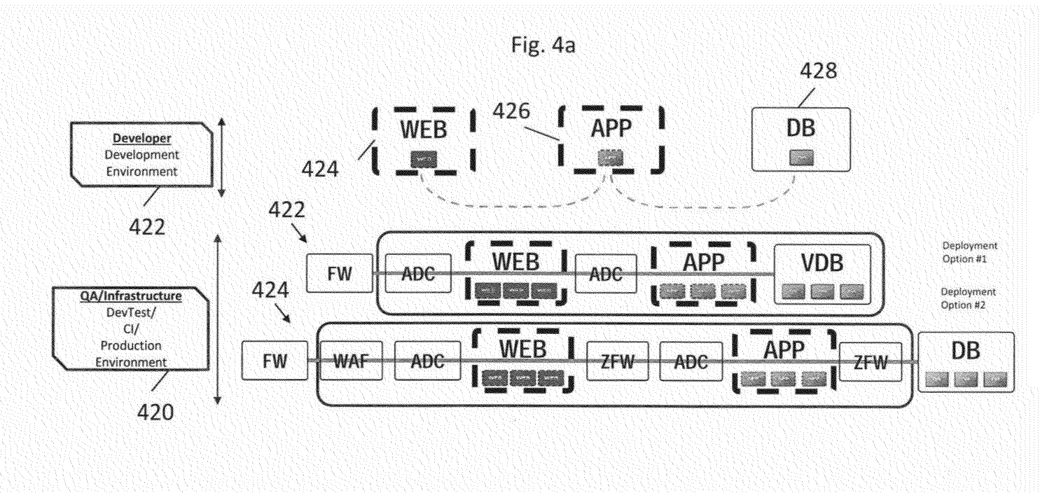

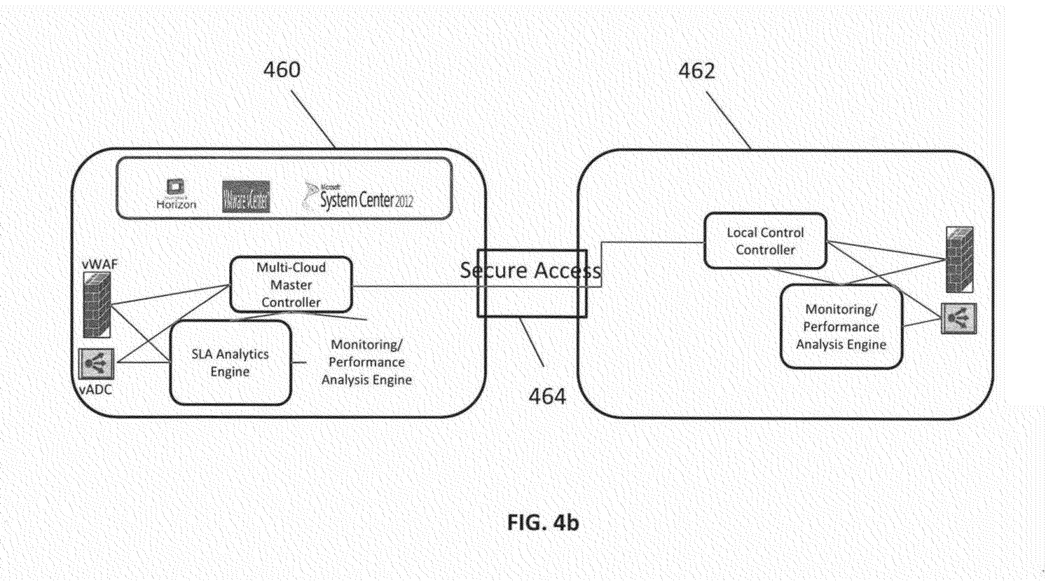

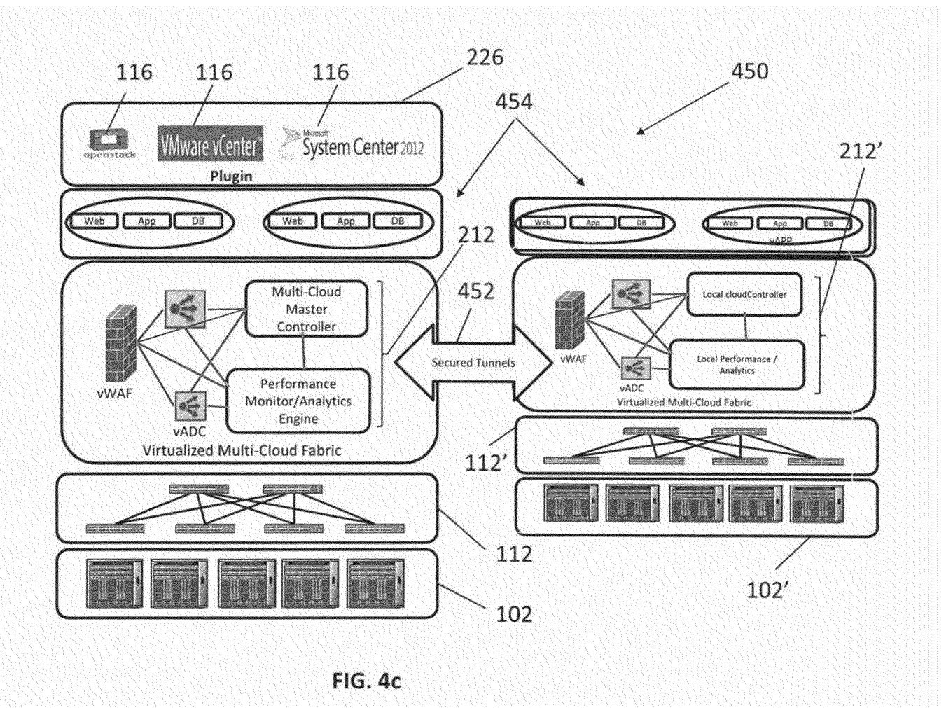

FIG. 4 shows, in conceptual form, relevant portion of a multi-cloud data center 400, in accordance with another embodiment of the invention. A client (or user) 401 is shown to use the data center 400, which is shown to include plug-in units 108, cloud providers 1-N 402, distributed elastic analytics engine (or “VAS unit”) 214, distributed elastic controller (of clouds 1-N) (also known herein as “flex cloud engine” or “multi-cloud master controller”) 232, tiers 1-N, underlying physical NW 416, such as Servers, Storage, Network elements, etc. and SDN controller 220.

Each of the tiers 1-N is shown to include distributed elastic 1-N, 408-410, respectively, elastic applications 412, and storage 414. The distributed elastic 1-N 408-410 and elastic applications 412 communicate bidirectional with the underlying physical NW 416 and the latter unilaterally provides information to the SDN controller 220. A part of each of the tiers 1-N are included in the service plane 216 of FIG. 2.

The cloud providers 402 are providers of the clouds shown and/or discussed herein. The distributed elastic controllers 1-N each service a cloud from the cloud providers 402, as discussed previously except that in FIG. 4, there are N number of clouds, “N” being an integer value.

As previously discussed, the distributed elastic analytics engine 214 includes multiple VAS units, one for each of the clouds, and the analytics are provided to the controller 232 for various reasons, one of which is the feedback feature discussed earlier. The controllers 232 also provide information to the engine 214, as discussed above.

The distributed elastic services 1-N are analogous to the services 318, 316, and 314 of FIG. 3 except that in FIG. 4, the services are shown to be distributed, as are the controllers 232 and the distributed elastic analytics engine 214. Such distribution allows flexibility in the use of resource allocation therefore minimizing costs to the user among other advantages.

The underlying physical NW 416 is analogous to the resources 114 of FIG. 1 and that of other figures herein. The underlying network and resources include servers for running any applications, storage, network elements such as routers, switches, etc. The storage 414 is also a part of the resources.

The tiers 406 are deployed across multiple clouds and are enablement. Enablement refers to evaluation of applications for L4 through L7. An example of enablement is stitching.

In summary, the data center of an embodiment of the invention, is multi-cloud and capable of application deployment, application orchestration, and application delivery.

In operation, the user (or “client”) 401 interacts with the UI 404 and through the UI 404, with the plug-in unit 108. Alternatively, the user 401 interacts directly with the plug-in unit 108. The plug-in unit 108 receives applications from the user with perhaps certain specifications. Orchestration and discover take place between the plug-in unit 108, the controllers 232 and between the providers 402 and the controllers 232. A management interface (also known herein as “management unit” 210) manages the interactions between the controllers 232 and the plug-in unit 108.

The distributed elastic analytics engine 214 and the tiers 406 perform monitoring of various applications, application delivery services and network elements and the controllers 232 effectuate service change.

In accordance with various embodiments and methods of the invention, some of which are shown and discussed herein, a Multi-cloud fabric is disclosed. The Multi-cloud fabric includes an application management unit responsive to one or more applications from an application layer. The Multi-cloud fabric further includes a controller in communication with resources of a cloud, the controller is responsive to the received application and includes a processor operable to analyze the received application relative to the resources to cause delivery of the one or more applications to the resources dynamically and automatically.

The multi-cloud fabric, in some embodiments of the invention, is virtual. In some embodiments of the invention, the multi-cloud fabric is operable to deploy the one or more native-format applications automatically and/or dynamically. In still other embodiments of the invention, the controller is in communication with resources of more than one cloud.

The processor of the multi-cloud fabric is operable to analyze applications relative to resources of more than one cloud.

In an embodiment of the invention, the Value Added Services (VAS) unit is in communication with the controller and the application management unit and the VAS unit is operable to provide analytics to the controller. The VAS unit is operable to perform a search of data provided by the controller and filters the searched data based on the user's specifications (or desire).

In an embodiment of the invention, the multi-cloud fabric system 106 includes a service unit that is in communication with the controller and operative to configure data of a network based on rules from the user or otherwise.

In some embodiments, the controller includes a cloud engine that assesses multiple clouds relative to an application and resources. In an embodiment of the invention, the controller includes a network enablement engine.

In some embodiments of the invention, the application deployment fabric includes a plug-in unit responsive to applications with different format applications and operable to convert the different format applications to a native-format application. The application deployment fabric can report configuration and analytics related to the resources to the user. The application deployment fabric can have multiple clouds including one or more private clouds, one or more public clouds, or one or more hybrid clouds. A hybrid cloud is private and public.

The application deployment fabric configures the resources and monitors traffic of the resources, in real-time, and based at least on the monitored traffic, re-configure the resources, in real-time.

In an embodiment of the invention, the multi-cloud fabric system can stitch end-to-end, i.e. an application to the cloud, automatically.

In an embodiment of the invention, the SLA engine of the multi-cloud fabric system sets the parameters of different types of SLA in real-time.

In some embodiments, the multi-cloud fabric system automatically scales in or scales out the resources. For example, upon an underestimation of resources or unforeseen circumstances requiring addition resources, such as during a super bowl game with subscribers exceeding an estimated and planned for number, the resources are scaled out and perhaps use existing resources, such as those offered by Amazon, Inc. Similarly, resources can be scaled down.

The following are some, but not all, various alternative embodiments. The multi-cloud fabric system is operable to stitch across the cloud and at least one more cloud and to stitch network services, in real-time.

The multi-cloud fabric is operable to burst across clouds other than the cloud and access existing resources.

The controller of the multi-cloud fabric receives test traffic and configures resources based on the test traffic.

Upon violation of a policy, the multi-cloud fabric automatically scales the resources.

The SLA engine of the controller monitors parameters of different types of SLA in real-time.

The SLA includes application SLA and networking SLA, among other types of SLA contemplated by those skilled in the art.

The multi-cloud fabric may be distributed and it may be capable of receiving more than one application with different formats and to generate native-format applications from the more than one application.

The resources may include storage systems, servers, routers, switches, or any combination thereof.

The analytics of the multi-cloud fabric include but not limited to traffic, response time, connections/sec, throughput, network characteristics, disk I/O or any combination thereof.

In accordance with various alternative methods, of delivering an application by the multi-cloud fabric, the multi-cloud fabric receives at least one application, determines resources of one or more clouds, and automatically and dynamically delivers the at least one application to the one or more clouds based on the determined resources. Analytics related to the resources are displayed on a dashboard or otherwise and the analytics help cause the Multi-cloud fabric to substantially optimally deliver the at least one application.

FIGS. 4a-c show exemplary data centers configured using embodiments and methods of the invention. FIG. 4a shows the example of a work flow of a 3-tier application development and deployment. At 422 is shown a developer's development environment including a web tier 424, an application tier 426 and a database 428, each used by a user for different purposes typically and perhaps requiring its own security measure. For example, a company like Yahoo, Inc. may use the web tier 424 for its web and the application tier 426 for its applications and the database 428 for its sensitive data. Accordingly, the database 428 may be a part of a private rather than a public cloud. The tiers 424 and 426 and database 420 are all linked together.

At 420, development testing and production environment is shown. At 422, an optional deployment is shown with a firewall (FW), ADC, a web tier (such as the tier 404), another ADC, an application tier (such as the tier 406), and a virtual database (same as the database 428). ADC is essentially a load balancer. This deployment may not be optimal and actually far from it because it is an initial pass and without the use of some of the optimizations done by various methods and embodiments of the invention. The instances of this deployment are stitched together (or orchestrated).

At 424, another optional deployment is shown with perhaps greater optimization. A FW is followed by a web-application FW (WFW), which is followed by an ADC and so on. Accordingly, the instances shown at 424 are stitched together.

FIG. 4b shows an exemplary multi-cloud having a public, private, or hybrid cloud 460 and another public or private or hybrid cloud 464 communication through a secure access 464. The cloud 460 is shown to include the master controller whereas the cloud 462 is the slave or local cloud controller. Accordingly, the SLA engine resides in the cloud 460.

FIG. 4c shows a virtualized multi-cloud fabric spanning across multiple clouds with a single point of control and management.

In accordance with embodiments and methods of the invention, load balancing is done across multiple clouds.

Although the description has been described with respect to particular embodiments thereof, these particular embodiments are merely illustrative, and not restrictive.

Disclosed herein are methods and apparatus for creating and publishing user interface (UI) for any cloud management platform with centralized monitoring, dynamic orchestration of applications with network services, with performance and service assurance capabilities across multi-clouds.

FIG. 5 shows an example of a controller unit 900 (also referred to herein as “controller unit 212” (shown in FIG. 2)), in accordance with embodiment of the invention. The controller unit 900 is shown to include a multi-cloud master controller 902 and software defined controller (SDN) 926, and optional slave controllers 933 in service public and private clouds. In accordance with an embodiment of the invention, the unit 900 is a cloud virtualization platform that may be implemented in hardware or software.

The multi-cloud master controller 902 is shown to include policy and event state machine 904. The policy and event state machine 904 defines and handles all the policies for every packet and event. It defines behavior of each module in the multi-cloud master controller 902. The multi-cloud master controller 902 is further shown to include database 906, configuration manager and load balancer as a service (LBaaS) plug-in 908, flex cloud health monitoring 910, SLA, and elasticity engine 912, high availability (HA) upgrade and downgrade manager 914, and SDN controller (network virtualization controller like, 916 and 926 collectively provide the abstraction for the “Open Daylight” and other . . . shown at the bottom left of FIG. 5.) controller compatibility abstraction 916. The database 906 contains all the information such as configuration, service plane instances, virtual machine (VM) scale up or scale down history, and state database. The configuration manager and LBaaS plug-in 908 pushes configuration to different resources and clouds and optionally to the slave controllers (distributed way of doing things). The flex cloud health monitoring 910 translates virtual machine creation/retrieval/update/delete requests to the appropriate cloud API. The SLA and elasticity engine 912 serves to provide performance assurance and capacity planning functions. The HA, upgrade and downgrade manager 914 provides high availability for the services controller as well as managing the upgrades and downgrades of various network services and other planes. The controller compatibility abstraction 916 supports different types of software defined network (SDN) and network virtualization controllers and includes the framework to convert the configuration/state/protocol information for these different types of SDN controllers. The slave controllers in 930 and 932 are responsible for providing a subset of the functionality done by the master controller but only for the cloud in which the slave controllers reside and synchronizing state information with the master controller. An example of a functionality subset is if master controller is any of the functions in FIG. 5 like 906, 908, 910 . . . and may do it's own analytics and elasticity but it would have to coordinate it with the master controller.

The multi-cloud master controller 902 is further shown to include a flow controller 918 in communication with a flow database 920. The flow database 920 maintains all active transmission control protocol (TCP) flows in its application data cache 936. Active TCP flows are saved in the flow databased 920 so that all the flow-related policies that were retrieved at flow-creation time can be applied to all the packets of the flow. Flow creation time is when the first packet arrives. “Flow”, as used herein refers to flow of data packets end-to-end, flows typically have data packets that are transmitted using different protocols. Yet, data packets must be understood by systems/devices transmitting and receiving them.

The multi-cloud master controller 902 is also shown to include analytics feedback 924 in communication with analytic feedback database 922. The analytic feedback is in communication with the value added services (VAS) planes 928. The analytics feedback 924 receives, on a continuous basis and typically from multiple clouds, feedback such as SLA violations, network state, and other events from the VAS planes 928, and analyzes and correlates the various feedback received from the VAS planes 928 and stores the analyzed information in the analytic feedback database 922.

The flow database 920 is shown to include application data cache 936 and the flow database is stored in application data cache 936. The application data cache 936 can be implemented in part, in either software or hardware.

The SDN controller 926, which includes software defined network programmability, such as those made by BigSwitch, VMWARE/Nicira, and other manufacturers, receives all the data from the network 938 and allows for programmability of a network switch/router. Floodlight, Open Daylight, and PDX are examples of Openflow SDN controllers. The Openflow switch is responsible for creating mirrored packets that are eventually sent to different services in substantially the same time for parallel processing.

The services controller 950, which may be one of the controllers 933, is an intelligent controller that checks for the flow to be received and if not, adds the flow to the subscriber table and retrieves information pertaining to the subscriber, such as, without limitation, subscriber policy from the PCRF 968. The fetched policy information may be about the kind of flows or other policy information. The controller 950 determines whether action needs to be taken on the flow and based on the action to be taken, programs the SDN controller 926 accordingly SDN controller. Examples of flow control are blocking the flow or redirecting it. As example of the latter a case when the subscriber runs out of money and its account balance is zero in which case the flow may be redirected to in a direction to allow replenishment of the subscriber's account.

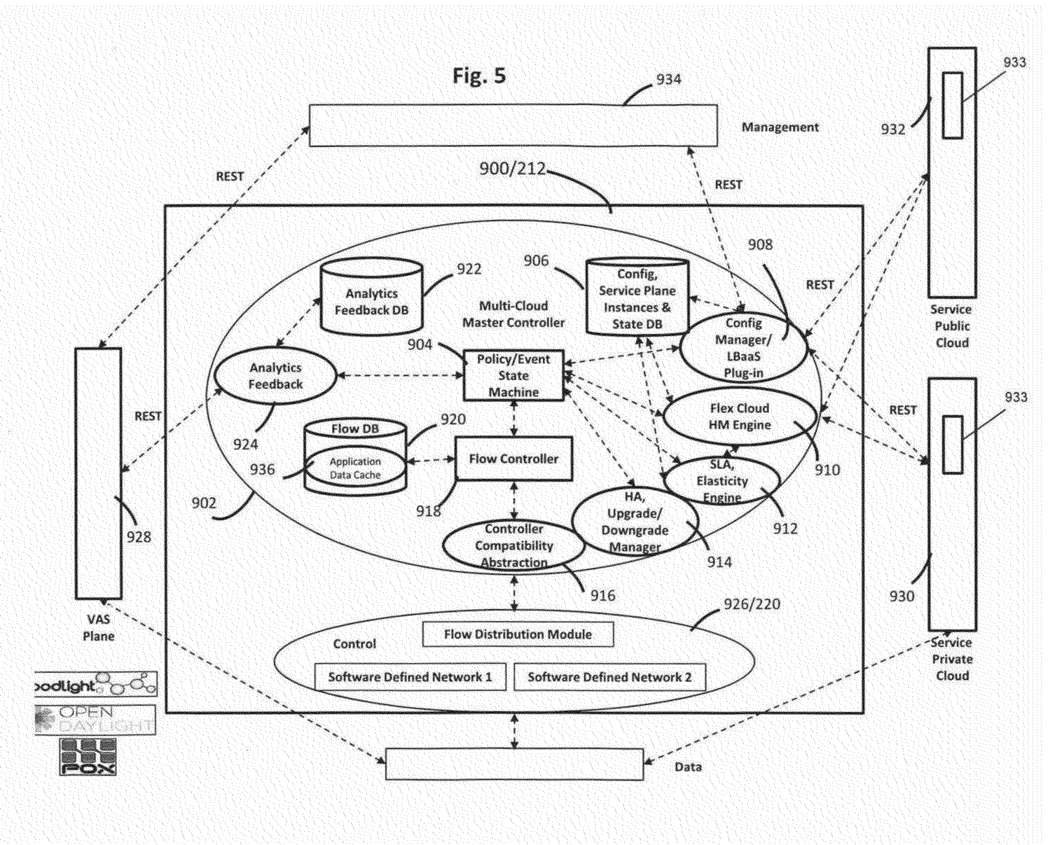

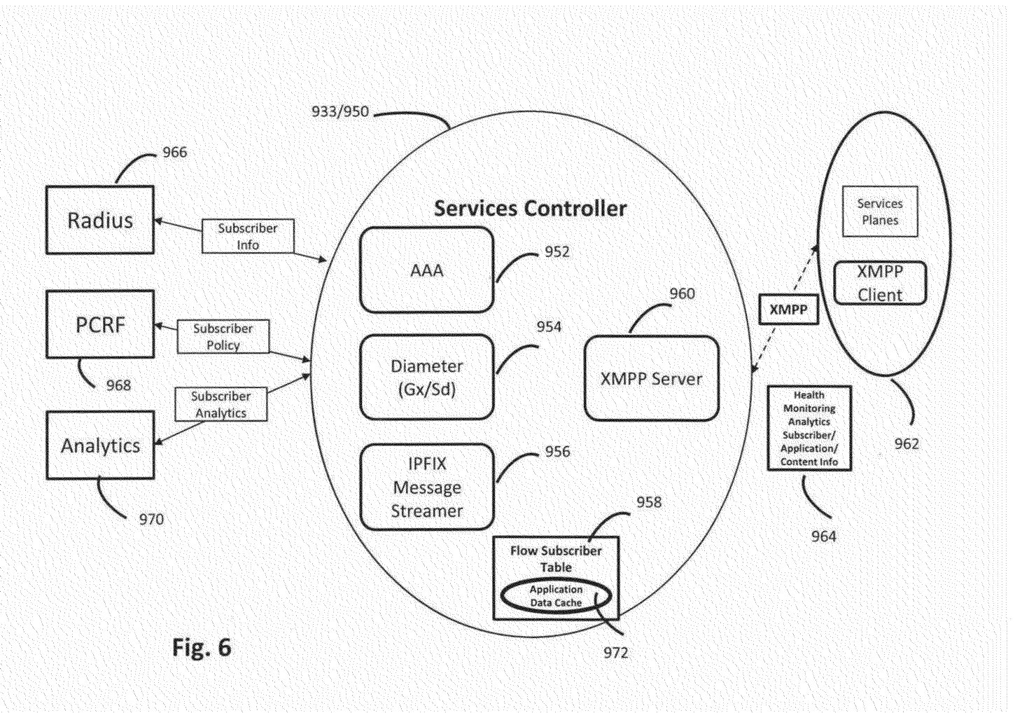

The block 964 monitors the health of the network services and performs actions accordingly, such as to bring back up the network services when it goes down or to instead, create an instance of the network service redirect to the created instance instead of the actual network service itself. “XMPP”, in FIG. 6, is an exemplary configuration protocol that is used for communication between the controller 950 and the planes/block 962/964. It is understood that any other configuration protocol may be used or a REST-based protocol may be alternatively used.

The services controller 950 (same as multi-cloud master controller), which may be one of the controllers 933, is an intelligent employs an exemplary RESTful architecture to provide an inter-operability framework with other RESTful applications using a simple and easy REST API interface. The controller unit 900 can be used as a plug-n-play controller and process enterprise web applications, cloud applications, cloud management platforms and various gateways. The flow database 936 (application data cache) is analogous to the flow subscriber table 958 but the latter has more features such as added network service.

As discussed above, in FIG. 6, the services controller 950 communicates network services, such as without limitation, how the network is configured and how data is retrieved from the network services, such as without limitation, subscriber policies, PCRF 968, subscriber information, radius 966, and subscriber analytics, analytics 970.

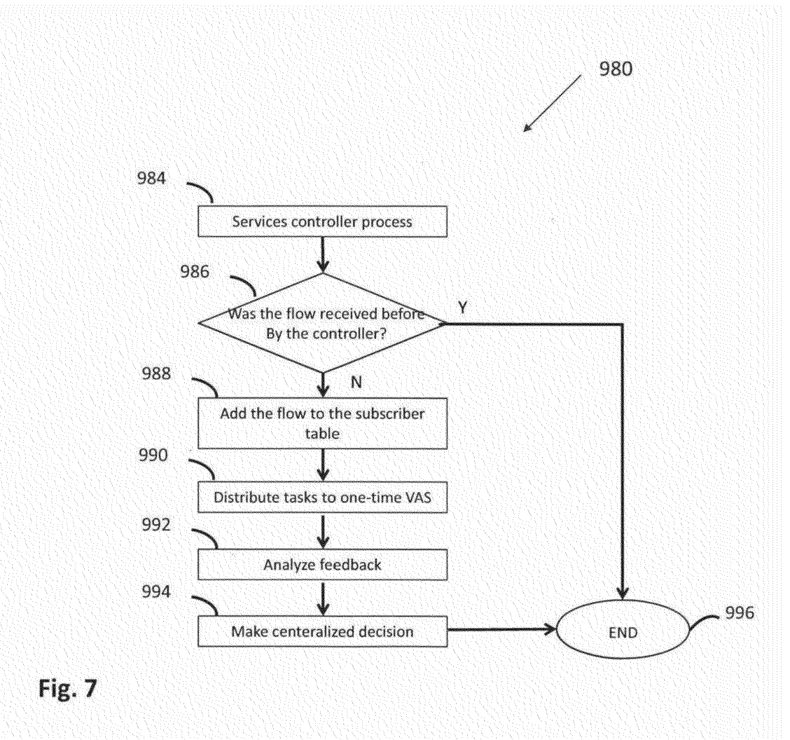

The subscriber 970 can be received in multiple formats and formatted in internet protocol flow information exchange (IPFIX) message streamer 956, an example of which is IPFIX (“IP flow”). The multi-cloud master controller 950 is more intelligent than that of prior art systems because it has services, such as those shown in FIG. 6. FIG. 7 shows how information is received. In FIG. 7, at 988, retrieved subscriber information and policies related to a subscriber are added to a subscriber table, such as the table 958, and then policy information, from VAS, is correlated and analyzed at step 992. At step 994, centralized decisions are made, such as how to program the SDN controllers, for example, whether the flow needs to be logged, determining the kind of flow, whether the flow needs to be redirected, etc. In such a scenario, no additional charges need be added to the account, and the flow can be redirected to recharging the account. Flows may be across multiple clouds.

As noted above, the block 964 monitors the health of the network service, like whether the network service went down in which case, it is brought back up. Also, because of having a virtualization environment, an instance of the foregoing service can be made and the flow can be redirected to the instance. The management unit 934 includes a user interface (UI) plug-in, an orchestrator compatibility framework, and applications. It receives applications of various formats and translates the various formatted application into native-format applications.

VAS planes 928 perform analytics based on distributed large data engine and crunch data and display analytics. They filter all of the logs based on the customer's (user's) desires. The VAS planes 928 also determine configurations such as who needs SLA, who is violating SLA, and the like. In accordance with various embodiments of the invention, an abstraction of VAS is created to allow communication with various VAS allowing for intelligent decisions to be made regarding network services. That is, because network services currently do not talk to each other, abstraction of VAS is done to centralize all VAS therefore making for an intelligible VAS by controller 900. Centralization refers to replacing having every network service talk to a subscriber database, rules, functions, an abstraction for all the network services is made so that they have one, i.e. the abstracted, network service, such as coming up with policies to apply. This is based on a standard API thereby preventing concerns about multiple protocols and only use one protocol. Diameter agent 954, accounting agent 952 and message streamer 956, shown in FIG. 6, are each examples of a VAS.

FIG. 6 shows an example of the services controller 950 in accordance with embodiment of the invention. The services controller 950 centralizes and unifies many type of different protocols and interfaces. The services controller 950 is shown to include authentication, authorization, and accounting (AAA) agent 952, diameter agent 954, and IPFIX message streamer 956.

The AAA agent 952 is in communication with Radius services 966. The AAA is used in distributed systems for controlling, which users are allowed access to which services, and tracking which resources they have used. Authentication refers to the process where an entity's identity is authenticated, typically by providing evidence that it holds a specific digital identity such as an identifier and the corresponding credentials. Examples of types of credentials are passwords, one-time tokens, digital certificates, and digital signatures. The authorization function determines whether a particular entity is authorized to perform a given activity, typically inherited from authentication when logging on to an application or service. Authorization may be determined based on a range of restrictions; for example, time-of-day restrictions, or physical location restrictions, or restrictions against multiple access by the same entity or user. Typical authorization in everyday computer life is, for example, granting read access to a specific file for a specific authenticated user. Examples of types of service include, but are not limited to internet protocol (IP) address filtering, address assignment, route assignment, quality of service/differential services, bandwidth control/traffic management, and encryption. Accounting refers to the tracking of network resource consumption by users for the purpose of capacity and trend analysis, cost allocation, and billing. In addition, it may record events such as authentication and authorization failures, and include auditing functionality, which permits verifying the correctness of procedures carried out based on accounting data. Real-time accounting refers to accounting information that is delivered concurrently with the consumption of the resources. Batch accounting refers to accounting information that is saved until it is delivered at a later time. Typical information that is gathered in accounting is the identity of the user or other entity, the nature of the service delivered, when the service began, and when it ended, and if there is a status to report.

The diameter agent 954 is communication with policy and charging rules function (PCRF) services. The diameter is an authentication, authorization, and accounting (AAA) protocol for computer networks. The PCRF is the software node designated in real-time to determine policy rules in a multimedia network. The PCRF is the part of the network architecture that aggregates information to and from the network, operational support systems, and other sources in real time, supporting the creation of rules and then automatically making policy decisions for each subscriber active on the network. PCRF can also be integrated with different platforms like billing, rating, charging, and subscriber database or can also be deployed as a standalone entity.

The IPFIX message streamer 956 is a common, universal standard of export for Internet Protocol flow information from routers, probes and other devices that are used by mediation systems, accounting/billing systems and network management systems to facilitate services such as measurement, accounting and billing. The IPFIX standard defines how IP flow information is to be formatted and transferred from an exporter to a collector. A metering process collects data packets at an observation point, optionally filters them and aggregates information about these packets. Using the IPFIX protocol, an exporter then sends this information to a collector.

The services controller also includes extensible messaging and presence protocol (XMPP) server 960 in communication with services planes 962 using a XMPP protocol. XMPP is a communications protocol for message-oriented middleware based on extensible markup language (XML). XMPP uses an open systems approach of development and application, by which anyone may implement an XMPP service and interoperate with other organizations' implementations. XMPP is a well-known configuration protocol but it is understood that other types of interfaces may be employed. Another example of a configuration protocol that may be used is REST-based or file transfer.

The services planes 962 include services such as application delivery controller (ADC), firewall, and virtual private network (VPN).

The services controller 950 is further shown to include flow subscriber table 958, which is analogous to flow database 920 of FIG. 5. The services controller 950 communicates with multiple services in parallel to expedite the discovery process about a flow and making centralized decisions based on the analytic feedback.

In an exemplary operation of the controller 900, the flow controller 918 controls the flow of a network services for either the cloud 932 or 930 or both and in the case of creating a instance, for example, using policies/events/analytics from the analytics feedback 924 and state machine 904. The controller compatibility abstraction 916 then provides the flow to the flow distribution module of the SDN controller 926. In some cases, the flow is not blocked and/or an instance is not created. The controller 918 retrieves flow information from the flow database 920 and similarly saved flow information therein. The Analytics feedback 924 saves and retrieves analytics information from and to the database 922 and also communicates the same with the VAS plane 928.

FIG. 7 shows a flow chart of some of the relevant steps 980 performed by the services controller 950, in accordance with various methods of the invention. The services controller 950 initiates the process at step 984 when the services controller 950 receives a flow. At step 986, a determination is made as to whether or not the same flow had already been received and analyzed by the services controller 950. The services controller 950 looks up the subscriber information in the flow subscriber table 958. If the same flow had already been received and analyzed by the services controller 950; “Y”, the controller 950 already posses all the analytical data regarding the flow and the process ends at step 996. If the flow doesn't exist in the flow subscriber table 958; “N”, the process proceeds to step 988. At step 988. The services controller 950 adds the flow to the flow subscriber table 958. Next at step 990, the services controller 950 initiates the discovery process about the flow by launching multiple tasks to the one-tine VAS. The one-time VAS includes services such as authentication, radius 966, PCRF 968, and analytics 970 (shown in FIG. 6). At step 992, the services controller 950 analyzes the feedbacks from VAS and the process proceeds to step 994. At step 994, the services controller 950 makes a centralized decision regarding the flow based on the analytical feedbacks received. And the process ends at step 996.

In an embodiment of the invention, the flow subscriber table 958 includes an application data cache 972 and the flow subscriber tables are stored in application data cache 972. The application data cache 972 can be implemented in part, in either software or hardware.

In another embodiment of the invention, the services controller 950 centralizes access to various value added services such as analytics engine, PCRF, Radius, SRC, among others and provides unified access via simple well-defined interfaces to various network and L4-L7 services complexes.

In some other embodiment of the invention, the services controller 950 routes flows or sessions to value added services (VAS). The VAS can come up with recommendations for deployment, provisioning and dynamically change the network and service complex characteristics.

In one embodiment of the present invention, the services controller 950 receives mirror packets and sends them to different services to be processed in parallel. The services controller 950 distributes the required services to VAS and L4-L7 services, collates and processes the feedbacks.

In yet another embodiment f the invention, the services controller 950 acts as a network service orchestrator. It automatically converts Network Virtual Function API from well-defined REST API and manages any vendors' network services such as Cisco VPN and Juniper APPFW from many cloud management platforms such as from Openstack.

The controller unit 900 (FIG. 5) with functions shown in FIG. 6, done by controller 950, makes network service intelligent by distributed, scaling up dynamically, zero-touch configuration and existing multiple clouds.

Accordingly, consistent development/production environments are realized. Automated discovery, automatic stitching, test and verify, real-time SLA, automatic scaling up/down capabilities of the various methods and embodiments of the invention may be employed for the three-tier (web, application, and database) application development and deployment of FIG. 4a. Further, deployment can be done in minutes due to automation and other features. Deployment can be to a private cloud, public cloud, or a hybrid cloud or multi-clouds.

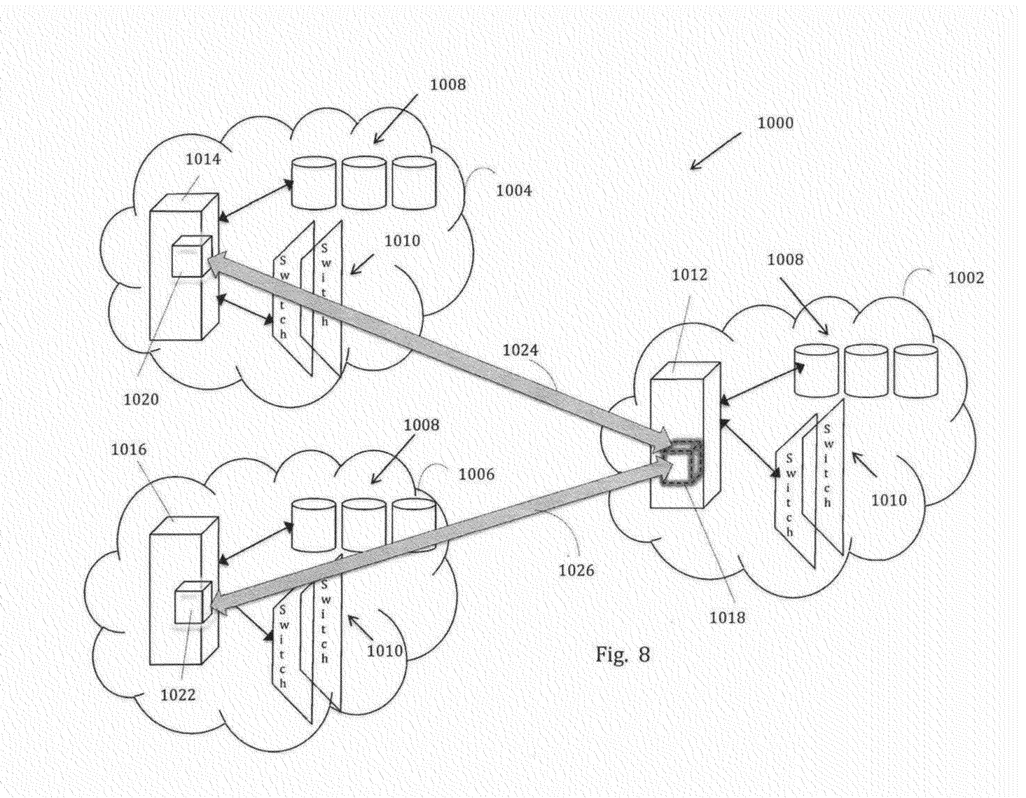

FIG. 8 shows a networking system 1000 using various methods and embodiments of the invention. The system 1000 is analogous to the data center 100 of FIG. 1, but shown to include three clouds, 1002-1006, in accordance with an embodiment of the invention. It is understood that while three clouds are shown in the embodiment of FIG. 8, any number of clouds may be employed without departing from the scope and spirit of the invention.

Each server of each cloud, in FIG. 8, is shown to be communicatively coupled to the databases and switches of the same cloud. For example, the server 1012 is shown to be communicatively coupled to the databases 1008 and switches 1010 of the cloud 1002 and so on.

Each of the clouds 1002-1006 is shown to include databases 1008 and switches 1010, both of which are communicatively coupled to at least one server, typically the server that is in the cloud in which the switches and databases reside. For instance, the databases 1008 and switches 1010 of the cloud 1002 are shown coupled to the server 1012, the databases 1008 and switches 1010 of cloud 1004 are shown coupled to the server 1014, and the databases 1008 and switches 1010 of cloud 1006 are shown coupled to the server 1016. The server 1012 is shown to include a multi-cloud master controller 1018, which is analogous to the multi-cloud master controller 232 of FIG. 2. The server 1014 is shown to include a multi-cloud fabric slave controller 1020 and the server 1016 is shown to include a multi-cloud fabric controller 1022. The controllers 1020 and 1022 are each analogous to each of the slave controllers in 930 and 932 of FIG. 5.

Clouds may be public, private or a combination of public and private. In the example of FIG. 8, cloud 1002 is a private cloud whereas the clouds 1004 and 1006 are public clouds. It is understood that any number of public and private clouds may be employed. Additionally, any one of the clouds 1002-1006 may be a master cloud.

In the embodiment of FIG. 8, the cloud 1002 includes the master controller but alternatively, a public cloud or a hybrid cloud, one that is both public and private, may include a master controller. For example, either of the clouds 1004 and 1006, instead of the cloud 1002, may include the master controller.

In FIG. 8, the controllers 1020 and 1022 are shown to be in communication with the controller 1018. More specifically, the controller 1018 and the controller 1020 communicate with each other through the link 1024 and the controllers 1018 and 1022 communicate with each other through the link 1026. Thus, communication between clouds 1004 and 1006 is conveniently avoided and the controller 1018 masterminds and causes centralization of and coordinates between the clouds 1004 and 1006. As noted earlier, some of these functions, without any limitation, include optimizing resources or flow control.

In some embodiments, the links 1024 and 1026 are each virtual personal network (VPN) tunnels or REST API communication over HTTPS, while others not listed herein are contemplated.

As earlier noted, the databases 1008 each maintain information such as the characteristics of a flow. The switches 1010 of each cloud cause routing of a communication route between the different clouds and the servers of each cloud provide or help provide network services upon a request across a computer network, such as upon a request from another cloud.

The controllers of each server of each of the clouds makes the system 1000 a smart network. The controller 1018 acts as the master controller with the controllers 1020 and 1022 each acting primarily under the guidance of the controller 1018. It is noteworthy that any of the clouds 1002-1006 may be selected as a master cloud, i.e. have a master controller. In fact, in some embodiments, the designation of master and slave controllers may be programmable and/or dynamic. But one of the clouds needs to be designated as a master cloud. Many of the structures discussed hereinabove, reside in the clouds of FIG. 8. Exemplary structures are VAS, SDN controller, SLA engine, and the like.

In an exemplary embodiment, each of the links 1024 and 1026 use the same protocol for effectuating communication between the clouds, however, it is possible for these links to each use a different protocol. As noted above, the controller 1018 centralizes information thereby allowing multiple protocols to be supported in addition to improving the performance of clouds that have slave rather than a master controller.

While not shown in FIG. 8, it is understood that each of the clouds 1002-1006 includes storage space, such as without limitation, solid state disks (SSD), which are typically employed in masses to handle the large amount of data within each of the clouds.

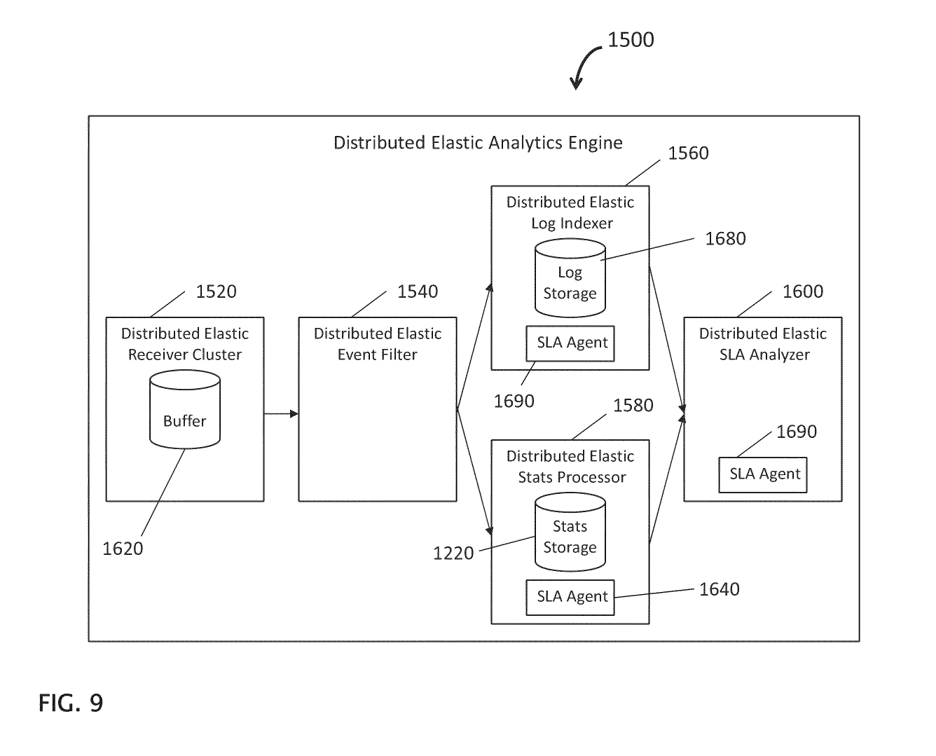

FIG. 9 shows an example of a distributed elastic analytic engine 1500, in accordance with methods and embodiments of the invention. The engine 1500 is analogous to the engine 214 of FIG. 4 herein. The distributed elastic analytics engine 1500 is shown to include distributed elastic receiver cluster 1520, distributed elastic event filter 1040, distributed elastic log indexer 1560, distributed elastic stats processor 5080, and distributed elastic SLA analyzer 1600; each of which perform a different task(s) and may be scattered across multiple clouds.

The distributed elastic receiver cluster 1520 is shown to include a buffer 1620 to aid slow processors that are next in the pipeline. The distributed elastic event filter 5040 processes events and de-multiplexes them onto various other processors that are down the execution pipeline and does so based upon the event type of event.

The distributed log indexer 1560 includes log storage 1680 for saving long-term logs associated with the events, for future reference. The distributed statistics (stats) processor 1580 is also shown to include stats storage 1220 for storing statistics associated with the events. The distributed elastic log indexer 1560 and distributed elastic stats processor 1580 process the logs and stats collected from the distributed elastic event filter 1540 and send the processed logs and stats to the distributed elastic SLA analyzer 1600.

The filter 1540 may filter the events, logs, or stats based on the user's choices and/or data content.

The distributed elastic SLA analyzer 1600 is shown to include a SLA agent 1660 and is shown to be in communication with the distributed elastic log indexer 1560 and the distributed elastic stats processor 1580. The analyzer 1600 analyzes and aggregates the processed logs and statistics (i.e. the network states) from the distributed elastic log indexer 1560 and the distributed elastic stats processor 1580.

The indexer 1560 is shown to include SLA agent 1690.

The processor 1580 is shown to also include a statistic storage 1220 and the SLA agent 1640. The stat storage 1220 is used by the processor 1580 to store statistical information from the events. The SLA agents 1690 and 1640 process the logs and statistical information that are stored in the log storage 1680 and stats storage 1220, respectively, and send the processed information to the distributed elastic SLA analyzer 1600.

In some embodiments of the invention, the engine 1500 is a part of the multi-cloud master controller 232 of FIG. 2 or implemented by the master controller or used by the master controller. In some embodiments, the engine is implemented using hardware and in other embodiments using software and in still other embodiments, using a combination of hardware and software.

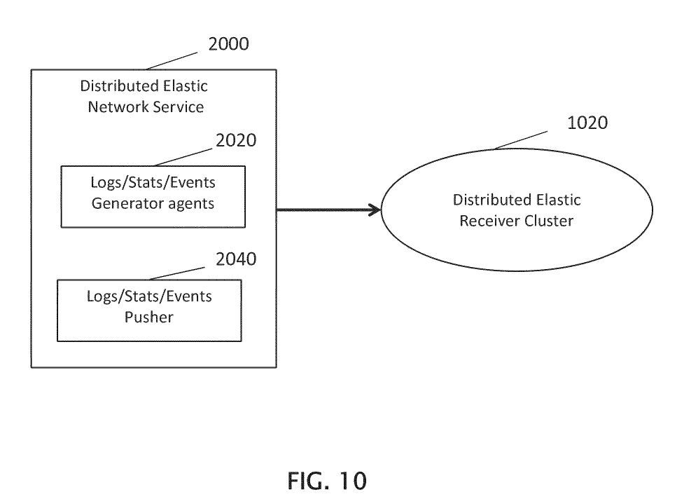

FIG. 10 shows an example of a distributed elastic network service 2000 in communication with the distributed elastic receiver cluster 1520 of FIG. 9, in accordance with embodiment and method of the invention. The network service 2000 is an example of the distributed elastic network services 408 and 410 of FIG. 4 hereinabove.

The network service 2000 is shown to include logs/stats/events generator agent 2020 and logs/stats/events pusher 2040 and in communication with the distributed elastic receiver cluster 1520 of FIG. 9. Accordingly, logs, stats, and events are pushed onto the cluster 1520. In situations where the pusher 2040 is absent or for network services that cannot be changed, stats, logs and events are pulled from the cluster 1520 instead of being pushed from the pusher 2040 onto the cluster 1520. That is, logs, stats, and events may be pulled directly from the network service itself instead of from the network service pushing this information onto the cluster 1520.

CPU usage, memory usage, storage usage, disk input/output operations per second, application response time, application throughput, application connections per second, application SSL connections per second are some examples of stats.

Access and Transaction Logs from the Application Delivery Controller, Web Application Firewall Logs from the Web Application Firewall, Attack Logs from the Web Application Firewall are some of the examples of stats.

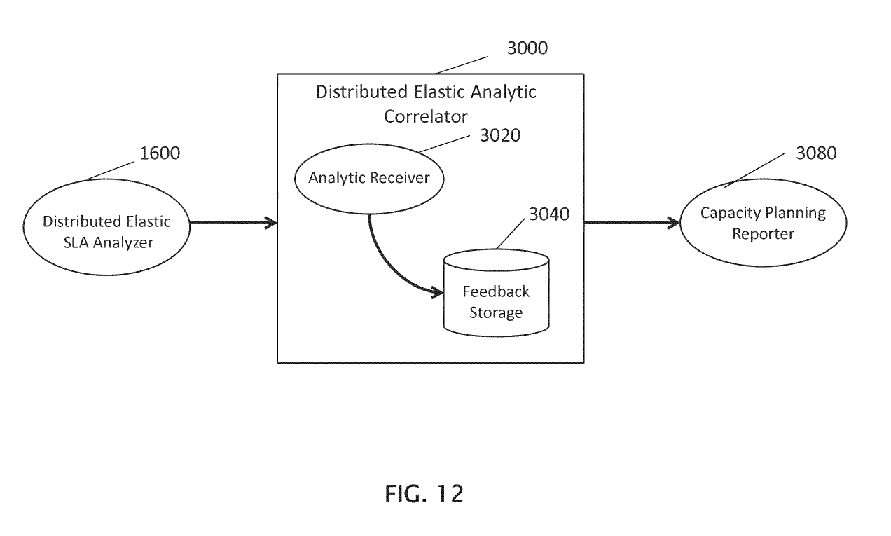

As previously indicated, examples of the network service 2000 are a load balancer, an application delivery controller, a web application firewall, or any other network service. In addition to retrieving logs/stats/events information from the network service 2000, cluster 1520 may retrieve information from other network elements, such as switches and routers to construct network state information and then correlate the network state information to the network service stats/logs/events information and make decisions based thereon. Accordingly, correlation is performed by the combination of the analyzer 1600 (FIG. 9) and the distributed elastic analytic correlator 3000 of FIG. 12. An exemplary system is shown in FIG. 12.

In one embodiment of the invention, the master controller 232 collects the network state information from various network services and correlates the same, as noted above, to make the decisions needed regarding to optimize the system.

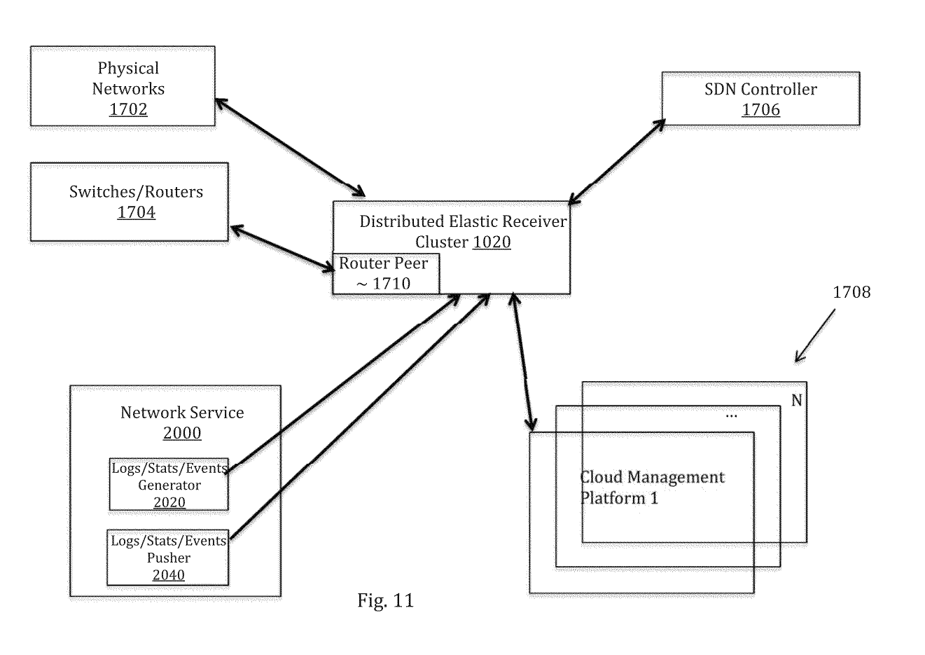

FIG. 11 shows, in block diagram form, a relevant portion of a data center with network elements, in accordance with an embodiment and method of the invention. Physical networks 1702, switches/routers 1704, network service 2000, the distributed elastic receiver cluster 1520, SDN controller 1706 and cloud management platforms 1-N 1708 are shown in FIG. 7. The cluster 1520 is shown to include a router peer 1710. The cloud management platforms 1-N 1708 are analogous to the cloud management platform 304 of FIG. 3 and multiple platforms are to accommodate multiple clouds. Thus, “N” number of clouds can be accommodate with “N” being an integer value. SDN controller 1706 is analogous to the SDN controller 220 of FIG. 4.

The cluster 1520 pulls from the cloud management platforms 1-N 1708 virtual network state that is information about respective clouds' physical network, such as without limitation, the performance of computer or hardware onto which the virtual network is running and how the virtual network state information is performing. Stated differently, the cloud management platform 1-N 1708 is needed because of the multi-cloud characteristic of the system of FIG. 11 and because it is a virtualized environment. Thus, information such as how computes are performing, how virtual networks are performing and how hard the hardware, i.e. central processing unit, memory, . . . , onto which the virtualized machine is running is performing are important to track, for obvious reasons. Accordingly, this type of information is pushed onto the cluster 1520 from the platforms 1-N 1708.

SDN controller 1706 pushes network state information about the physical network, onto the cluster 1520. Network state information can also be directly retrieved from the physical switches, routers and other network elements 1704. Yet alternatively, the router peer 1710 can be added to collect routing information.

FIG. 12 shows an example of a distributed elastic analytic correlator 3000 residing on the service controller, in accordance with embodiment and method of the invention. The distributed elastic analytic correlator 3000 is shown to include analytic receiver 3020 and analytic feedback storage 3040 and in communication with distributed elastic SLA analyzer 1600 and capacity planning reporting 3080. The aggregated information from the distributed elastic SLA analyzer 1600 is sent to the distributed elastic analytic correlator 3000 in the service controller. The distributed elastic analytic receiver 3020 receives aggregated information from the (distributed and elastic) SLA analyzer 1600 and stores the received information in the analytic feedback storage 3040. The stored feedback information is sent to capacity planning reporter 3080 for generating capacity planning reports.

Event correlation simplifies and speeds the monitoring of network events by consolidating alerts and error logs into a short, easy-to-understand package.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A multi-cloud fabric system comprising:
a master controller in communication with cloud resources of multiple clouds and including a distributed elastic analytics engine, the distributed elastic analytics engine including,
a log storage;
a first SLA agent;
a statistics storage; and
a second SLA agent, wherein the log storage and the first SLA agent make up a distributed elastic log indexer and the statistics storage and the second SLA agent make up a distrusted elastic stats processor,
a distributed elastic SLA analyzer including a third SLA agent, wherein the distributed elastic log indexer and the distributed elastic stats processor are each responsive to events from an events filter,
wherein the distributed elastic SLA analyzer, using the first, second and third SLA agents and from the log storage and statistics storage is operable to analyze and aggregate processed logs and statistics from the distributed elastic log indexer and the distributed elastic stats processor.

2. The multi-cloud fabric system, as recited in claim 1, wherein the multi-cloud fabric system is virtual.

3. The multi-cloud fabric system, as recited in claim 1, wherein the multi-cloud fabric system is physical.

4. The multi-cloud fabric, as recited in claim 1, wherein the multi-cloud fabric system is made of hardware.

5. The multi-cloud fabric system, as recited in claim 1, wherein the multi-cloud fabric system is made of software.

6. The multi-cloud fabric system, as recited in claim 1, wherein the multi-cloud fabric system is made of hardware and software.

7. The multi-cloud fabric system, as recited in claim 1, wherein the aggregated logs are communicated to a distributed elastic analytic correlator, the distributed elastic analytic correlator being operable to generate correlated state information from more than one network services.

8. The multi-cloud fabric system, as recited in claim 1, further including links wherein the master controller and the multiple clouds are in communication with each other through the links.

9. The multi-cloud fabric system, as recited in claim 8, wherein the links are virtual personal network (VPN) tunnels or REST API communication over HTTPS.

10. The multi-cloud fabric system, as recited in claim 1, wherein all clouds of the multiple clouds, other than the cloud including the master controller, each include a slave controller controlled by the master cloud.
